(19) United States
(12) Patent Application Publication
(10) Pub. No.: US 2023/0394460 A1
(43) Pub. Date: Dec. 7, 2023

(54) LOCATION-BASED DIGITAL ASSET INTERACTION

(71) Applicant: Rhizomenet Pty. Ltd., Melbourne (AU)

(72) Inventor: Yue Wang, Melbourne (AU)

(21) Appl. No.: 17/834,802

(22) Filed: Jun. 7, 2022

(51) Int. Cl. G06Q 20/32; G06Q 20/38; G06Q 20/36

(52) U.S. Cl. CPC G06Q 20/3224; G06Q 20/3829; G06Q 20/3678; G06Q 20/4012

(57) ABSTRACT

A computer-implemented method of interacting with a digital asset which is associated with a crypto-wallet stored at a server or server cloud. The server or server cloud permits a client device to interact with the digital asset conditional upon the client device's location being present in a list of one or more locations stored in correspondence with a private key, which secures the digital asset in the crypto-wallet. Interaction includes using the private key to claim ownership of the digital asset, or, using the public key to view the digital asset and/or digital property associated with the digital asset.

### FIELD OF THE INVENTION

The present invention relates to a method of interacting with, or providing access to, a digital asset based at least on the geographical location of a client device.

### BACKGROUND

A cryptographic wallet is generally considered to be a list of one or more public-private key pairs. Each key pair may be associated with a digital asset (e.g., an ERC-20, ERC 721, ERC-1155 token) stored on a blockchain: the public key effectively represents an address for the digital asset on the blockchain as well as a means to identify the owner of the asset, and the private key is considered proof of ownership of the digital asset (e.g. a signature generated using a private key may be properly verified using the public key hence proving that the signer has possession of the private key). The key pairs may be related to one other (e.g., in a deterministic wallet, where all key pairs are derived from a single mnemonic), or not (e.g., in a non-deterministic wallet, where each key pair is derived from an independent random number). All existing wallets are, however, agnostic in the geographical sense, meaning the owner of a wallet is able to send and/or receive a digital asset regardless of their, or the other parties, locations.

### SUMMARY

According to a first aspect of the present invention there is provided a computer-implemented method of interacting with a digital asset, which is associated with a cryptographic wallet stored at a server or server cloud. In the method, the server or server cloud permits a first client device to interact with the digital asset conditional upon that client device's location. The cryptographic wallet comprises a private key which secures the digital asset and a list of one or more locations stored in correspondence with the private key for this reason. The method, performed at the server or server cloud, comprises determining that the first client device is present at a location corresponding to a location in the cryptographic wallet and, in response, sending a digital tag, associated with the digital asset, to the first client device thereby causing the first client device to display the digital tag as an augmented reality image on a display interface of the first client device. The method further comprises sending the private key, a public key associated with the private key, or that public-private key pair to the first client device. The first client device is then able to interact with the digital asset by: importing and/or sweeping the private key to a cryptographic wallet of a user of the first client device; or using the public key to view the digital asset and/or a digital property associated with the digital asset.

Importing and/or sweeping the private key may constitute transfer of ownership of the digital asset.

The digital asset may be a fungible token, for example a crypto-currency value, or a non-fungible token (NFT), for example associated with a digital artwork or an executable AI program.

The step of determining that the first client device is present at a location corresponding to a location in the cryptographic wallet may include receiving the first client device's location from the first client device.

The list of one or more locations and the private key may be received at the server or server cloud from a second client device, which is, for example, the owner of the digital asset.

The digital tag may be caused to be displayed as an augmented reality image on the display interface of the first client device at a position indicative of the location contained in the cryptographic wallet.

The step of sending the private key may be performed after determining that the first client device has received user input indicating its user wishes to acquire the digital asset. Likewise, the step of sending the public key may be performed after determining that the first client device has received user input indicating its user wishes to view the digital asset and/or digital property associated with the digital asset. Alternatively, the public or private key may be sent concurrently with digital tag.

The server or server cloud may further permit a client device to interact with the digital asset conditional upon further information being present in one or more lists stored in correspondence with the private key at the server or server cloud.

The lists may be of: one or more time slots, one or more future time periods, one or more image triggers, one or more passwords, passphrases or PIN numbers and/or one or more identifiers, which are received from the second client device. The further information may include a time, an image, a password, passphrase or PIN number and/or a username.

The step of sending the digital tag, private key, public key and/or public-private key may therefore be performed after receiving, from the first client device, a time within a timeslot in the timeslot list, an image in the image trigger list, a password, passphrase or PIN number in the password, passphrase or PIN number list and/or a username in the identifier list.

The location in the crypto-wallet may be defined by data that represents a position of a celestial object (e.g., an altitude-azimuth position of a star). The server or server cloud may then permit the first client device to interact with the digital tag conditional upon the first client device demonstrating it is at an orientation indicative or consistent with the first client device being directed or oriented towards the celestial object.

According to a second aspect of the present invention there is provided a computer-implemented method of providing a user of a first client device access to interact with an AI program, which is stored at a server or server cloud. In the method, first client device is provided access to interact with the AI program conditional upon that client device's location being present in a list of one or more locations which is stored by the server or server cloud and in correspondence with the AI program. The method, performed by the first client device, comprises: demonstrating to the server or server cloud that the first client device is present at a location corresponding to a location stored by the server or server cloud and, in response, receiving a character model, from the server or server cloud, representing the AI program and displaying the character model as an augmented reality image on a display interface of the first client device. The method further comprises determining that the user wishes to interact with the AI program, and in response providing the user with access to an interface to interact with the AI program.

The first client device may demonstrate it is present at a location in the list of one or more locations stored at the server or server cloud by sending its location to the server or server cloud.

The location stored at the server or server cloud may be defined by data that represents a position of a celestial object (e.g., an altitude-azimuth position of a star). The first client device may then send its orientation to the server or server cloud such that it can determine that that orientation is indicative of the first client device being directed at, or oriented towards the celestial object.

A second client device may generate the list of one or more locations and send the list and the AI program to the server or server cloud to store in correspondence with each other.

The AI program may be trained by the server or server cloud. For example, the server or server cloud may continuously run the AI program.

The first client device may receive the character model conditional upon providing further information to the server or server cloud which is present in one or more lists stored in correspondence with the AI program at the server or server cloud.

The lists may be of: one or more time slots, one or more future time periods, one or more image triggers, one or more passwords, passphrases or PIN numbers and/or one or more identifiers, which are received from the second client device. The further information may include a time, an image, a password, passphrase or PIN number and/or a username.

Said step of receiving the character model may therefore occur after the first client device sends to the server or server cloud: a time within a timeslot in the timeslot list, an image in the image trigger list, a password, passphrase or PIN number in the password, passphrase or PIN number list and/or a username in the identifier list.

### BRIEF DESCRIPTION OF THE DRAWINGS

FIG. 1 is a flow diagram showing how a user of a client device can set up a “location-based” crypto-wallet;

FIG. 2 is a flow diagram showing how a user of a client device can interact with a digital asset associated with a “location-based” crypto-wallet;

FIG. 3 is a schematic illustration of an augmented reality interface of a client device; and

FIG. 4 is a flow diagram showing how a client device is provided access to interact with an AI program.

### DETAILED DESCRIPTION

This disclosure concerns a “location-based” cryptographic wallet (herein “location based” crypto-wallet), managed by a server or server cloud. Unlike traditional crypto-wallets, the location-based crypto-wallet stores location information, which is used to determine whether a “target” client device is permitted to interact with (e.g., claim ownership of) a digital asset associated with a key stored in the crypto-wallet based at least on the location of the client device. NB. The terms “client device” and “user” as used hereinbelow may to some extent be interchangeable. The latter may refer to a user in possession of and using a client device.

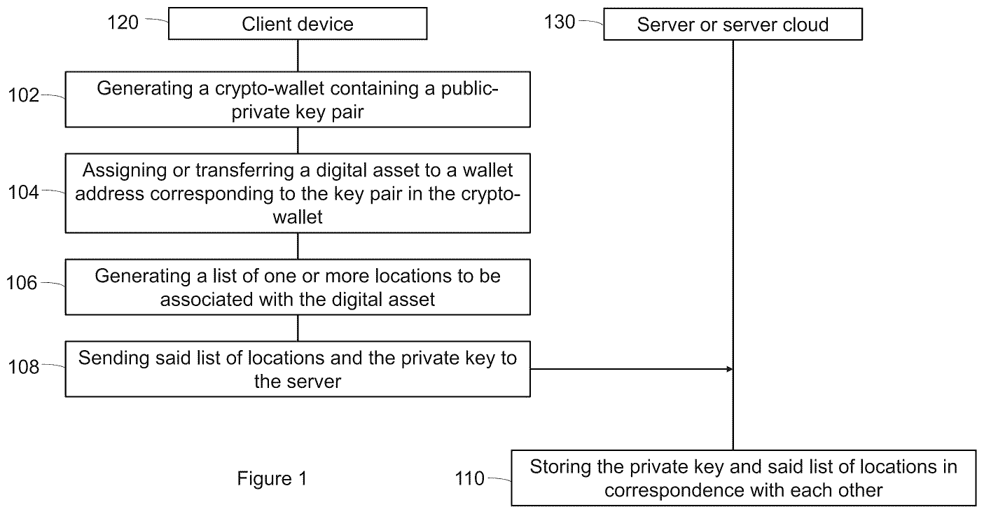

FIG. 1 illustrates how a user of a “source” client device 120 can set up a location-based crypto-wallet on the server or server cloud 130 for the target user to interact with. The source client device 120 may be a smartphone, tablet, wearable device (e.g., smart watch, or smart glasses) or the like, which is able to connect with the server or server cloud 130 over a suitable communication network or combination of communication networks (e.g., Wi-Fi, cellular, broadband fibre etc.).

In step 102, the source client device 120 generates a “location-agnostic” crypto-wallet (e.g., a conventional Electrum wallet), containing a list of one or more public-private key pairs. Each key pair is associated with a wallet address. That address might be the public key itself, or a cryptographic derivative (e.g., a hash) of the public key. For example, in Bitcoin, a wallet address is computed as RIPEMD160(SHA256(public key)), whereas in Ethereum, the address is taken as the last 20 bytes of KECCAK256(public key).

The crypto-wallet may be either deterministic or non-deterministic. That is, each key pair in the list may be generated deterministically (e.g., using BP-32) from a single mnemonic, input by the user (e.g., using BIP-39) at wallet creation, or randomly. It should be understood that when the key pairs in the list are generated, they need not be associated with a digital asset—they may initially be unallocated or “empty”. It is also possible to copy (known as “importing”) a key pair associated with a digital asset from one of the user's other wallets directly into the new wallet. The source client device may generate the wallet and the keys that is contains directly on the device, or may cause these to be generated on the server or server cloud. In the former case, the device may transfer the wallet to the server or server cloud.

In optional step 104, a digital asset is assigned or transferred to a wallet address in the crypto-wallet through a blockchain transaction. For example, the user of the source client device 120 initiates a blockchain transaction to assign a Non-Fungible Token (NFT) from a wallet address of a local crypto-wallet of the source client device to a wallet address in the crypto-wallet established on the server. In another example, the user of the client device 120 purchases a digital asset through a smart contract to effect transfer of the digital asset to a wallet address the server-based crypto-wallet. It will be appreciated by the skilled reader that each public-private key pair may be associated with more than one digital asset.

In step 106, a list of one or more locations is generated to be associated with the one or more digital assets in the crypto-wallet. The locations in the list may be a geographical location or area on the Earth or another planetary body (e.g., Mars). Alternatively, the locations in the list may be defined by data indicative of a geographical location or area on Earth or another planetary body. References herein to a location in the location-based crypto-wallet should be interpreted accordingly.

The data indicative of a geographical location could be a position of a celestial object For example, the altitude-azimuth position of a star in the sky. As the altitude-azimuth position of a celestial object is dependent on the geographical location of the observer at the time and date of measurement, the altitude-azimuth position of a celestial object is indicative of that geographical location. Put differently, a subsequent observer (e.g., a user of the client device) would need to be present at that geographical location at an equivalent time in order to view the celestial object at that corresponding angular position in the sky.

A geographical location may be represented by a point (e.g., a latitude and longitude), or an area (e.g., a square in a predetermined gridded map). For example, in what3words™ a square area is represented by a unique permutation of three words. The number and location of the geographical locations may be generated randomly by the client device 120, input by the user of the client device 120 (either manually or through loading of a file), and/or generated in response to a search query input by the user. For example, the user may query “Parks in London”, specify “5” locations and the client device returns five random locations in a park in London (e.g., Hyde Park, Richmond Park etc.). This functionality could be implemented in an application running on the client device 120 (e.g. the ZOME™ app), using appropriate APIs with which the skilled reader will be familiar and as described for example in WO/2021/121932.

In step 108, the client device 120 sends the generated list of locations and the private key(s) associated with the one or more digital asset(s) to the server or server cloud 130. Optionally, the client device 120 further sends the public key (wallet address).

In step 110, the server or server cloud 130 stores the private key (or public-private key pair, or wallet address—private key pairing, as the case may be) and the list of locations in correspondence with each other, thereby generating a “location-based” crypto-wallet.

The client device 120 may perform all or some of the steps in the method of FIG. 1 whilst running an application (e.g., the ZOME™ app). As the skilled reader appreciates, the application therefore has the required functionality to enable the client device to interact with any one or more of: a crypto-wallet client application (e.g., on Electrum) in steps 102 and 104; a blockchain (e.g., Ethereum) or nodes thereof in step 104; and the server or server cloud 130 in step 108.

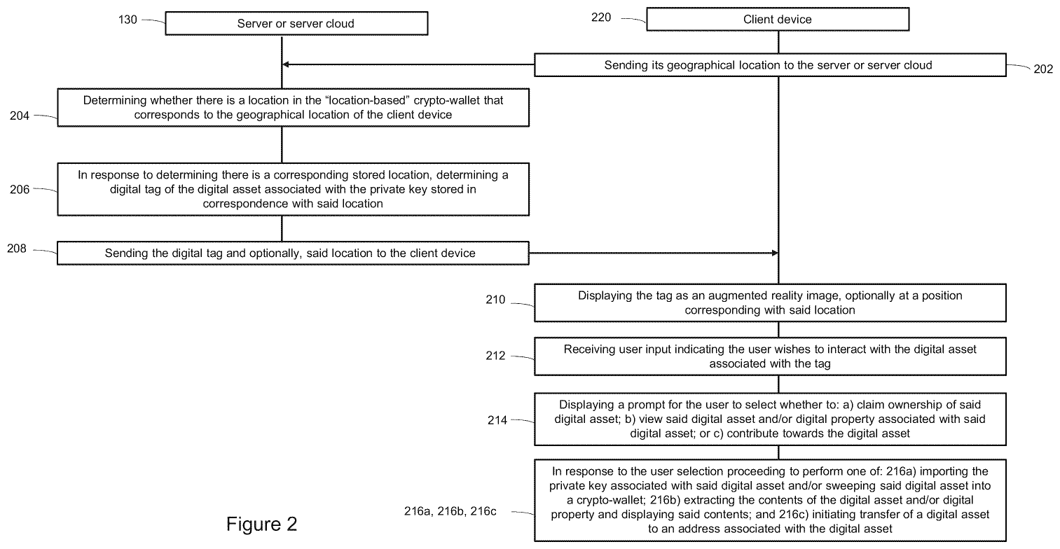

FIG. 2 illustrates how a user of a target client device 220 can interact with a digital asset associated with the location-based crypto-wallet stored on the server or server cloud 130. The client device 220 may be a smartphone, tablet, wearable device (e.g., smart watch, or smart glasses) or the like, which is able to connect with the server, or server cloud over a suitable communication network (e.g., Wi-Fi, cellular, broadband fibre etc.).

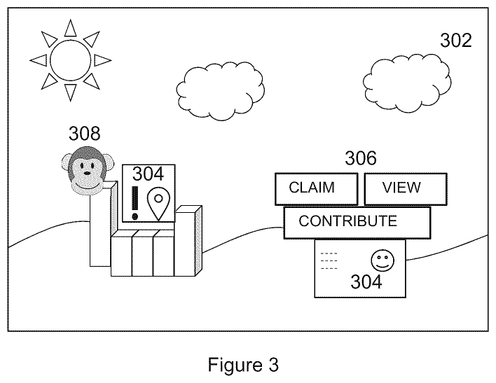

In the method shown in FIG. 2, the target client device 220 is running an application (e.g., the ZOME™ app), which is able to display content (e.g., a tag or pin) to the user via an interface (e.g., an augmented reality (AR) interface) at a particular location. The application may be the same application referred to in FIG. 1. A schematic illustration of the augmented reality interface is shown in FIG. 3. In an example, the content is overlaid on a live image/video captured using a camera of the client device when the ZOME app is open, or overlaid on a transparent display (e.g., smart glasses) which the user “sees through” to view a real image. The client device 220 may include depth sensing equipment (e.g., a LiDAR scanner, motion sensors etc.) in order to display graphical content more accurately at the desired location, although this is not essential. The target user client, e.g. via the ZOME app, may have subscribed to the location-based crypto wallet created by the source client device.

In step 202, the target client device 220 sends its geographical location to the server or server cloud 130. The target client device 220 may send its geographical location periodically (e.g., every 60 seconds) or every time its position changes by an amount greater than a predetermined threshold (e.g., 2 metres, each instance the client device's position enters a different square grid in a predetermined gridded map etc.).

In step 204, the server or server cloud 130 determines whether there is a location in the location-based crypto-wallet which corresponds with the geographical location of the client device 220.

If the location in the location-based crypto-wallet is a geographical point or area, two geographical points correspond if they are separated by a distance less than a predetermined threshold (e.g., 5 metres). Two geographical areas correspond if they relate to the same gridded area in a predetermined gridded map.

If the location in the location-based crypto-wallet is defined by data indicative of that location, the geographical location of the client device corresponds with said data if the client device 220 is present at the geographical location defined by that data. For example, the data may be a star position, measured at a particular geographical location. If the client device is present at the same geographical location, then the locations are considered to correspond. Correspondence may also be determined by considering whether a given location falls within a specified geographical region.

In response to determining that there is a corresponding location stored in the crypto-wallet, the server or server cloud 130 determines, in step 206, a tag of the digital asset associated with the private key, the private key being stored in correspondence with said location.

The tag may be generated in advance (e.g., as the server 130 receives the private key from the client device 120, by the client device 120 as part of set-up of the location-based crypto-wallet) or concurrently with step 206. The digital tag may include an image including text (e.g., “NFT Bored Ape Yacht Club”), a still image or a video image (which might be an animation), or an audio clip, associated with the digital asset. In some examples, the digital tag may not include any information related to the digital asset itself. For example, the digital tag may be a pin or other icon (e.g., an exclamation mark).

In an example, the digital tag is generated by querying a blockchain explorer tool (e.g., Etherscan for the Ethereum blockchain) with the wallet address(es) associated with the digital asset(s) and extracting data and/or metadata of the digital asset stored on the blockchain.

Preferably, although not necessarily, the server or server cloud 130 is the entity that generates the digital tag. It is, however, also possible that client device 120, which sets up the “location-based” crypto-wallet, generates and sends a digital tag in step 108. The latter approach, however, may be vulnerable to spoofing by the source client device 120, unless the server 130 verifies the digital tag.

In a specific example, the digital asset is a NFT and the digital tag includes an image of the creator of the NFT, or the creator of the digital property associated with the NFT, and the title of the NFT, which are retrieved from data (e.g., metadata) stored on the blockchain. The digital property itself (e.g., digital artwork), which is associated with the NFT may, however, be stored “off-chain” (e.g., on the OpenSea™ platform) or in some other digital “vault”. The skilled reader will appreciate that the storage location of the digital property is nevertheless obtainable from data stored on the blockchain (e.g., via the smart contract address that minted the NFT, through the ID of the creator of the NFT etc.).

As has already been noted, a public-private key pair in the “location-based” crypto-wallet may be associated with more than one digital asset (e.g., more than one NFT). In some examples therefore, the digital tag may be associated with more than one item of digital property.

In step 208, the server or server cloud 130 sends the digital tag to the client device 220. Optionally, the server or server cloud 130 also sends the location determined to correspond with the geographical location of the client device 220 and any one of: the public-private key pair, private key, public key, a cryptographic derivative of the public key (e.g., wallet address) or private-key-wallet-address pairing.

In step 210, the client device 220 displays the digital tag in the interface of the client device 220 as an augmented reality image. Optionally, the digital tag is displayed at a position corresponding to or indicative of the location received from the server or server cloud 130.

In step 212, the client device 220 receives user input indicating that the user wishes to interact with the digital asset associated with the digital tag. This user input may correspond to the user tapping on the displayed digital tag. In another example, where the target client device is or comprises a pair of smart glasses having a camera, the input may result from a hand or other gesture performed by the user.

In step 214, the client device 220 may display a prompt in the interface for the user to select whether they wish to (a) claim ownership of the digital asset 212a, (b) view the digital asset stored “on-chain” and/or digital property associated with the digital asset stored “off-chain” 212b, or (c) contribute towards the digital asset 212c. For example, the client device 220 displays the following selectable prompts to the user: “CLAIM”, “VIEW” and “CONTRIBUTE”.

If the user selects the prompt to claim ownership of the digital asset, the client device 220 proceeds to perform step 216a of: i) importing (i.e., copy) the private key associated with the digital asset into a crypto-wallet owned by the user; and/or ii) sweeping (i.e., initiate a blockchain transaction using the private key and a public key/wallet address owned by the user) the digital asset into that crypto-wallet.

If the user selects the prompt to view the digital asset and/or the digital property associated with the digital asset, the client device 220 proceeds to perform step 216b of extracting the contents of the digital asset and/or digital property and displaying the contents in the interface. The extracted content may be displayed to the user as an augmented reality image. The extracted content may be text, a video, audio, a 2D image, a 3D image, an animation (e.g., a character model of an AI program) or the like.

As an example, the client device 220 queries a blockchain explorer, using the public key or wallet address associated with the digital asset, in order to either: i) extract the contents of the digital asset; or ii) determine the “off-chain” storage location (e.g., a URI) of the digital property associated with the digital asset in order to extract the contents of the digital property.

In an example, the digital property is a digital artwork associated with an NFT, which is stored in a server owned by an NFT platform or in IPFS (Interplanetary File system). After the off-chain storage location of the digital artwork is known, the client device 220 is able to query appropriate server(s) to retrieve the digital artwork.

In another example, the digital property is an executable artificial intelligence (AI) program (e.g. GPT-3, GPT-n) stored on a server, which generates “human-like” text in response to a query. Alternatively, the AI program (e.g., DALL-E) generates images in response to a query. The client device 220 may interact with the AI program locally (e.g., by downloading the AI program on the client device) or remotely by sending and receiving data packets over a network to a server running the AI program.

If the user selects the prompt to contribute towards the digital asset, the target client device 220 proceeds to perform step 216c of initiating transfer of a digital asset to the address associated with the digital asset. In an example, the target client device 220 initiates a blockchain transaction to transfer its own digital assets (using its own private key) to the wallet address corresponding to the digital asset related to the digital tag. For example, the digital asset may be an ERC-1155 token (a smart contract) to raise money for charity and the user can choose to deposit its own tokens (e.g., ERC-20) to the smart contract address.

As, in step 208, the server or server cloud 130 optionally sends any one of: the public-private key pair, private key, public key, wallet address or private-key-wallet-address pairing, to the target client device 220, the client device 220 may not, at step 214, have received the required information to proceed to perform the steps of 216a, 216b or 216c above. In some examples therefore, the client device 220 first sends a request to the server or server cloud 130 to receive the required information (i.e., the private key, public key, wallet address etc.) such that it can perform those steps (216a, 216b or 216c).

The crypto-wallet proposed in this disclosure has thus far been referred to as “location-based”. However, it should be understood that the “location-based” crypto-wallet may store additional information in correspondence with the private key (or key pair), thereby placing further conditions upon a client device wishing to interact with it.

In this light, the client device 120 of FIG. 1 may additionally generate (step 106b) and send (step 108b) to the server or server cloud 130 any one or more of:
a list of one or more time slots;
a list of one or more future time periods;
a list of one or more image triggers;
a list of one or more passwords, passphrases or PIN numbers; and/or
a list of one or more identifiers.

Each of the above lists is stored in correspondence with the private key (or key pair) in the location-based crypto-wallet at the server or server cloud 130, which is already stored in correspondence with the list of one or more locations.

The time slots are specified periods in a day (e.g., 00:00 to 10:00, 20:30 to 23:00 etc.).

The future time periods may be a specified month, year, decade or ranges thereof, meaning the digital asset is only accessible to a client device (e.g., 220) in that particular month, year, decade or range.

The image trigger may be an image of an entity. For example, a well-known landmark, the logo of a shop, a constellation, and the like. This disclosure places no limitation on it.

Each identifier in the list of identifiers may be a username of an account on the application (e.g., ZOME™ app), which the client devices 120, 220 run in the methods of FIG. 1 and FIG. 2. The server or server cloud 130 may therefore maintain a record containing the user credentials (e.g., username and password) of each user following enrolment of that user on the application (e.g., ZOME™ app). Each account username uniquely defines an account profile and is searchable by querying the server or server cloud 130, for example, using a search tool in-built in the application (e.g., ZOME™ app).

Correspondingly, the client device 220 in step 202b may additionally send any one of more of: the current time (e.g., time of day, date), an image (e.g., the image currently being displayed in the interface of the client device 220), and its username to the server 130.

The “location-based” check in step 204 may therefore additionally include further checks based on time, an image trigger, a password and an identifier. In particular, the server or server cloud 130 then additionally determines whether:
the current time received from the client device 220 is within a time slot stored at the server or server cloud 130;
the image received from the client device 220 contains the same entity (e.g., the same constellation) as an image trigger stored at the server or server cloud 130; and
the username received from the client device 220 is identical to an identifier stored at the server or server cloud,
   and further whether each said time slot, image trigger and identifier is stored in correspondence with the same private key before sending the digital tag to the client device 220. Step 206 should be interpreted accordingly.

In a specific example, the “location-based” check by the server or server cloud 130 further involves determining that the client device 220 is “viewing” a celestial object in the sky. As has been described above, the location in the location-based crypto-wallet may be defined by data indicative of a location (e.g., the altitude-azimuth position of a celestial object) as well as a viewing time and date. To demonstrate to the server 130 that the client device 220 is actually viewing the celestial object, the user of the client device 220 orients the client device 220 in the direction of the celestial object in the night sky and sends this orientation to the server or server cloud 130 (e.g., in step 202). Optionally, a velocity may also be sent. The orientation and velocity of the client device 220 can be measured with an accelerometer and/or gyroscope built into the client device 220. Using the received orientation data (and the geographical location of the client device 220) and a current time and date, the server or server cloud 130 can determine that the orientation corresponds with the altitude-azimuth position of the celestial object and hence is directed at it.

In a specific example, the account username of the user running the application (e.g., ZOME™ app) in FIG. 2 is a public key of a private-public key pair, but different from the key pairs stored in any of the crypto-wallets. The server or server cloud 130, which maintains a record of the credentials of users that have enrolled with the application, may subsequently select and use the appropriate public key to encrypt data being sent to a particular user in order that only that user is able to decrypt it using its private key.

FIG. 3 is a schematic illustration of a display of an augmented reality interface of the client device 220. The interface comprises a “real world view” 302 (i.e., a camera feed, or a transparent display through which the real world can be viewed directly) upon which graphical content is overlaid. More particularly, the graphical content includes any one or more of: one or more digital tags 304 (e.g., a pin, exclamation mark, an image of the creator of the digital asset/property and the title of the digital asset, etc.); one or more prompts 306 (e.g., “CLAIM”, “VIEW” or “CONTRIBUTE” etc.); one or more items of digital property 308 (e.g., an image of digital artwork, a character model of an AI program etc.)

This disclosure also proposes a “location-based” AI managed by a server or server cloud, which a client device is able to interact with based at least on the location of the client device.

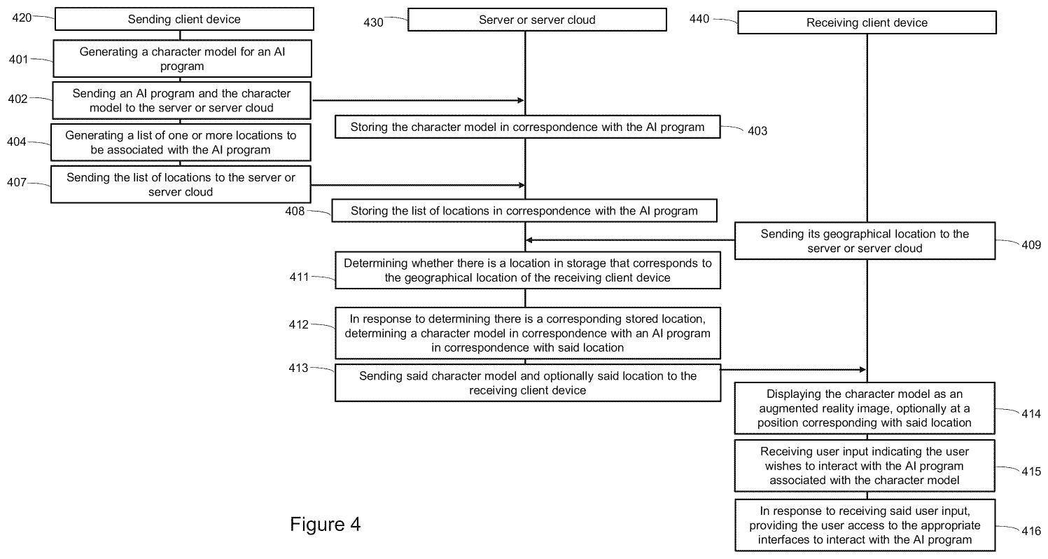

FIG. 4 illustrates how a receiving or target client device 440 is provided access to interact with an AI program stored at a server or server cloud 430 based at least on its location. A sending or source client device 420 is used to set up the AI program. In the method, each client 420, 440 may run the same application (e.g., the ZOME™) referred to above. Each client device 420, 440 may be a smartphone, tablet, wearable device (e.g., smart watch, or smart glasses) and the like, which is able to connect with the server, or server cloud over a suitable communication network (e.g., Wi-Fi, cellular, broadband fibre, etc.).

In step 401, the sending client 420 generates a character model representing an AI program. The character model may for example represent a digital person. In an example, the user of the sending client 420 sets any one or more of: a personality trait, speech pattern, vocal tone, vocal pitch, skin tone, age, height, gender, hair colour etc., using functionality built into the application (e.g., ZOME™ app) which the client device 420 runs. In another example, the user uploads a 2D, 3D or voice/text representation (e.g., of a real person) for the digital person.

In step 402, the sending client 420 sends an AI program and the character model for the AI program to the server or server cloud 430.

The AI program may be an existing text or image generator (e.g., GPT-3, GPT-n, DALL-E). Alternatively, the AI program may be generated by executing an existing AI program and using its outputs to train/produce a new AI. In yet another example, the AI program monitors the phone and/or online activity of the user that the AI program is intended to represent in order to learn their behaviour. The AI program might, for example, learn a user's personality trait, their beliefs from their online activity, whereas it might learn their vocal tone and pitch from audio conversations online. The AI program may therefore be trained on the server or server cloud.

In step 403, the server or server cloud 430 stores the AI program and character model in correspondence. Optionally, the server 430 runs the AI program continuously, or periodically, such that the AI program is able to learn the behaviour of the person it is intended to represent. The location of the AI program on the server or server cloud 430 may be tokenised (e.g., uniquely represented as an NFT) and said NFT may then be transferred or assigned to a crypto-wallet (e.g., the “location-based” crypto-wallet).

In step 404, the sending client device 420 generates a list of one or more locations to be associated with the AI program. The list of one or more locations can be generated in any manner described above (e.g., as detailed in step 106).

In optional steps 405 and 406, the sending client 420 generates and sends any one or more of: a list of one or more time slots, a list of one or more future time periods, a list of one or more image triggers, a list of one or more passphrases, passwords or PIN numbers, and a list of one or more identifiers in an analogous manner to step 106b described above. The details are not repeated here for conciseness.

In step 407, the sending client 420 sends the list of one or more locations to the server or server cloud 430.

In step 408, the server or server cloud 430 stores the list of locations in correspondence with the AI program.

In step 409, the receiving client device 440 sends its geographical location to the server or server cloud 430.

In optional step 410 the receiving client device 440 sends any one of more of: the current time (e.g., time of day, date), an image (e.g., the image currently being displayed in the interface of the receiving client device 440), and its account username to the server 430, in an analogous manner to step 202b described above. The details are not repeated here for conciseness.

In step 411, the server or server cloud 430 determines whether it stores a location that corresponds to the geographical location of the receiving client device 440. In response to determining that there is a corresponding stored location, the server or server cloud 430 determines, in step 412, the character model stored in correspondence with an AI program which, in turn, is stored in correspondence with said stored location.

Analogously with FIG. 2, the “location-based” check in step 411 may additionally include further checks based on time, an image trigger, a password and an identifier. In particular, the server or server cloud 430 may additionally determine whether:
the current time received from the client device 440 is within a time slot stored at the server or server cloud 430;
the image received from the client device 440 contains the same entity (e.g., the same constellation) as an image trigger stored at the server or server cloud 430; and
the username received from the client device 440 is identical to an identifier stored at the server or server cloud,
   and further whether each said time slot, image trigger and identifier is stored in correspondence with the same AI program. Step 412 should be interpreted accordingly.

The server or server cloud 430 may also determine that the client device 440 is oriented or directed towards a celestial object, before performing step 413. This option has been described in detail above in relation to the location-based crypto-wallet and is not repeated here.

In step 413, the server or server cloud 430 sends said character model and optionally said location to the receiving client device 440.

In step 414, the receiving client device 440 displays the character model in the interface of the client device 440 as an augmented reality image. Optionally, the character model is displayed at a position corresponding or indicative to the location received from the server or server cloud 430.

In step 415, the receiving client device 440 receives user input (e.g., a touch input on the character model) indicating the user wishes to interact with the AI program associated with the displayed character model.

In step 416, in response to receiving said user input, the receiving client device 440 provides the user of the receiving client device 440 access to an appropriate interfaces/tool such that the user can interact with the AI program.

Such tools/interfaces are known to the skilled reader. However, in a specific example envisaged in this disclosure, the receiving client device 440 provides an interface that allows the user to input voice commands hands-free. Active listening of the interface may be activated using a phrase (i.e., a hot-word) such as “Hey AI bot” or the like. The interface may further provide a text box (e.g., as an augmented reality image adjacent to the displayed character model) to allow text input by the user.

Users may also interact with the AI program using physical movements. These inputs are then sent to the server or server cloud 430 and a response from the AI program is returned to the client device 440. The response may be displayed (e.g., in the text box interface) to the user or output through a speaker of the client device 440.

In an example, the physical movement is a hand gesture. As the skilled reader will appreciate, the hand gesture can be detected using any suitable detecting element: LiDAR, sonar, a temperature sensor, an accelerometer or the like. The sensors may be built into the receiving client device 440 or provided in advance close to the “real-world” location corresponding to the AI program. For example, the AI program might represent a deceased actress, which is made available to the public at a movie premiere with sophisticated sensors provided to improve interactivity.

As the skilled reader will appreciate, there are other working examples in which some of the steps in FIG. 4 are combined, performed concurrently (e.g., steps 402 and 407) or performed in a different order (e.g., step 401 may come after step 404).

Although the invention has been described in terms of preferred embodiments, as set forth above, it should be understood that these embodiments are illustrative only and that the claims are not limited to those embodiments. Features from different examples may be combined as appropriate to form other working examples.

1. A computer-implemented method of interacting with a digital asset, the method comprising:
providing a crypto-wallet at a server or server cloud, the crypto-wallet comprising: (i) a private key that secures the digital asset and possession of which proves ownership of the digital asset and (ii) a list of one or more locations stored in correspondence with the private key, wherein providing the crypto-wallet comprises:
generating, by a second client device, the crypto-wallet comprising the private key;
assigning, by the second client device, a digital asset to a wallet address corresponding to the private key in the crypto-wallet;
generating, by the second client device, the list of one or more locations to be associated with the digital asset; and
sending, by the second client device, the list of one or more locations and the private key to the server or server cloud;
determining, by the server or server cloud, that a first client device is present at a location corresponding to a location in said crypto-wallet, and in response, sending, by the server or server cloud, a digital tag associated with the digital asset and the private key which secures the digital asset, to the first client device;
displaying, by the first client device, the digital tag as an augmented reality image on a display interface of the first client device;
importing and/or sweeping, by the first client device, the private key to a crypto-wallet of a user of the first client device; and
in response to importing and/or sweeping the private key to the crypto-wallet of the user of the first client device, transferring the ownership of the digital asset to the user.

2. The method according to claim 1, wherein the digital asset is a fungible token, comprising a crypto-currency value, or a non-fungible token (NFT) associated with a digital artwork or an executable artificial intelligent (AI) program.

3. The method according to claim 1, wherein determining that a first client device is present at a location corresponding to a location in said crypto-wallet comprises receiving from the first client device, the first client device's location.

4. (canceled)

5. The method according to claim 1, wherein the digital tag is displayed as the augmented reality image on the display interface of the first client device at a position indicative of said location.

6. The method according to claim 1, wherein the server or server cloud sends the private key after determining that the first client device has received user input indicating that the user wishes to acquire the digital asset.

7. A method according to claim 1, wherein the server or server cloud further receives from the second client device any one or more of:
a list of one or more time slots;
a list of one or more future time periods;
a list of one or more image triggers;
a list of one or more passwords, passphrases or PIN numbers; and/or
a list of one or more identifiers, and
stores said one or more lists in correspondence with the private key, and
the method further comprises sending the digital tag and the private key conditional upon information, received from the first client, being present in one or more of the lists and stored in correspondence with the private key.

8. The method according to claim 7, wherein the information includes a time, an image, a password, a passphrase, or PIN number and/or a username.

9. The method according to claim 1, wherein said location in the crypto-wallet is defined by data representing a position of a celestial object, and before sending the digital tag, the server or server cloud determines that:
an orientation received from the first client device demonstrates that the first client device is directed or oriented towards the celestial object.

10.-16. (canceled)
